(19) United States
(12) Patent Application Publication
(10) Pub. No.: US 2024/0049742 A1
(43) Pub. Date: Feb. 15, 2024

(54) SYSTEM FOR PROCESSING LIQUID FOR SEMI-LIQUID FOOD PRODUCTS

(71) Applicant: ALI GROUP S.R.L. - CARPIGIANI, Cernusco Sul Naviglio (MI) (IT)

(72) Inventors: Roberto LAZZARINI, Reggio Emilia (RE) (IT); Federico TASSI, Bologna (IT)

(21) Appl. No.: 18/362,374

(22) Filed: Jul. 31, 2023

(30) Foreign Application Priority Data
Aug. 11, 2022 (IT) 202022000003417
Dec. 13, 2022 (IT) 202022000005139

(51) Int. Cl. A23G 9/22; A23G 9/28; A23G 9/14; B01F 27/1145; B01F 35/12; B01F 27/17; B01F 27/724; B01F 35/93

(52) U.S. Cl. CPC A23G 9/224; A23G 9/281; A23G 9/14; B01F 27/11451; B01F 35/123; B01F 27/17; B01F 27/724; B01F 35/93; B01F 2101/13

(57) ABSTRACT

A system for processing liquid or semi-liquid food products includes a machine provided with:
at least one containment vessel for containing the product to be processed;
a stirrer arranged inside the containment vessel;
   the system is characterized in that said stirrer includes, in combination, at least:
a rotating body rotating about an axis of rotation, said rotating body including a plurality of propellers extending about said axis of rotation;
a plurality of scraping elements, supported by said rotating body;
a drive shaft, connectable to the rotating body, for the rotation of the rotating body about the axis of rotation;
a curvilinear element extending around the axis of rotation and configured to be inserted inside the rotating body and rotatably coupled with the drive shaft.

The present invention relates to a system for processing food products (liquid and/or semi-liquid and/or semi-solid).

In particular, the present innovation refers to the processing systems comprising machines for producing and dispensing food products such as ice creams, whipped cream, creams, chocolate, yoghurt, jams and the like.

Generally, such machines comprise a containment vessel for containing the product to be processed, a stirrer arranged inside the vessel for mixing the product and at least one dispensing tap arranged on the lower front of the vessel.

Generally, the stirrer is mainly responsible for processing and mixing the product to be dispensed and ensuring a certain consistency to the product itself.

A particularly felt need in the sector is that this consistency is uniform in every part of the product to be dispensed.

Stirrers are known that also include scraping elements of the containment vessel so that all the products can remain under constant processing, avoiding accumulations of product on the walls of the vessel.

The processing and the physical transformation of the food product is carried out by the stirrer which, through its shape and rotation, allows the movement of the mass of product in the freezing step and, through the scraping elements, removes the layer of frozen mixture from the walls permitting a continuous freezing process of the liquid phase.

A particularly felt need in the sector in question is to be able to have a processing system equipped with a stirrer that allows to perform, at the same time, the following functions:
mixing and amalgamating the mixture during the cooling step;
generating an air exchange in the mixture;
constantly scraping the chamber wall by removing the layer of solid mixture;
providing the necessary head to expel the mixture once it is blended.

Furthermore, since the stirrer, due to its function, remains in contact with the product, it is necessary to carry out frequent and adequate cleaning operations thereon.

A further need felt in the sector is therefore to facilitate the dismounting of the stirrer (in particular the disassembly of the components thereof) if necessary.

The aim of this innovation is to meet the above requirements, i.e. to propose a system for processing food products that is able to implement all the functions mentioned above.

In particular, the aim of the present invention is to realize a system for processing liquid food products in which the stirrer allows:
mixing and amalgamating the mixture during the cooling step;
generating an air exchange in the mixture;
constantly scraping the chamber wall by removing the layer of solid mixture;
providing the necessary head to expel the mixture once it is blended;
being able to be easily disassembled (e.g. for cleaning purposes).

Said aim is fully achieved by the system object of this innovation, which is characterized by what is contained in the claims below.

The technical characteristics of the innovation and the advantages thereof are highlighted in the following description of a preferred but not for this reason limiting embodiment.

This description refers to the accompanying drawings, which are also given purely by way of non-limiting example, in which:

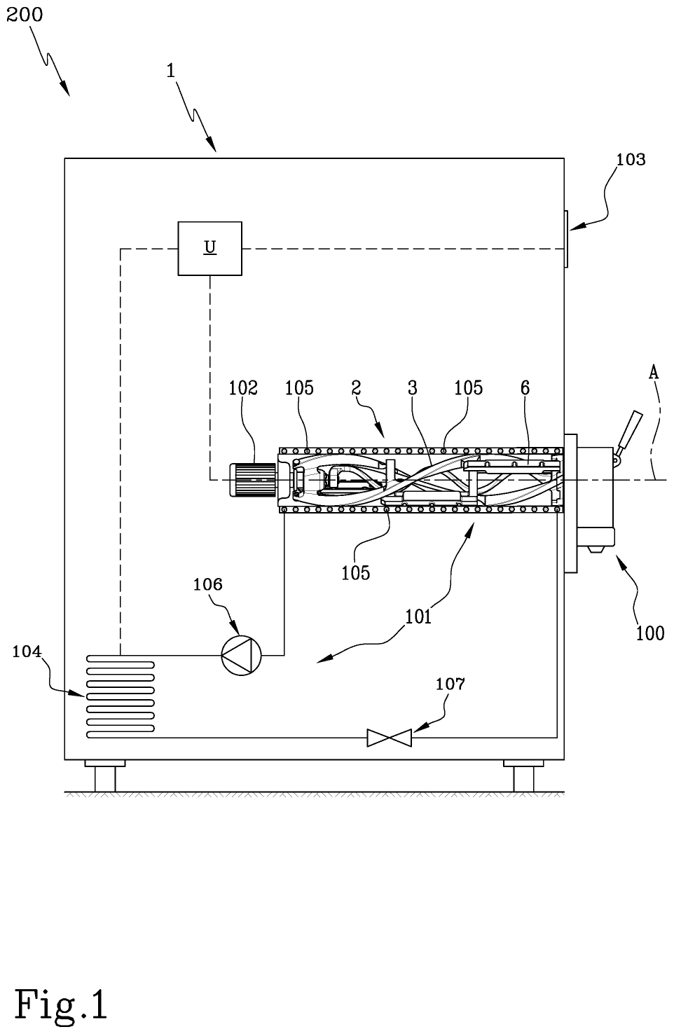

FIG. 1 illustrates a schematic side view of the system according to the present innovation;

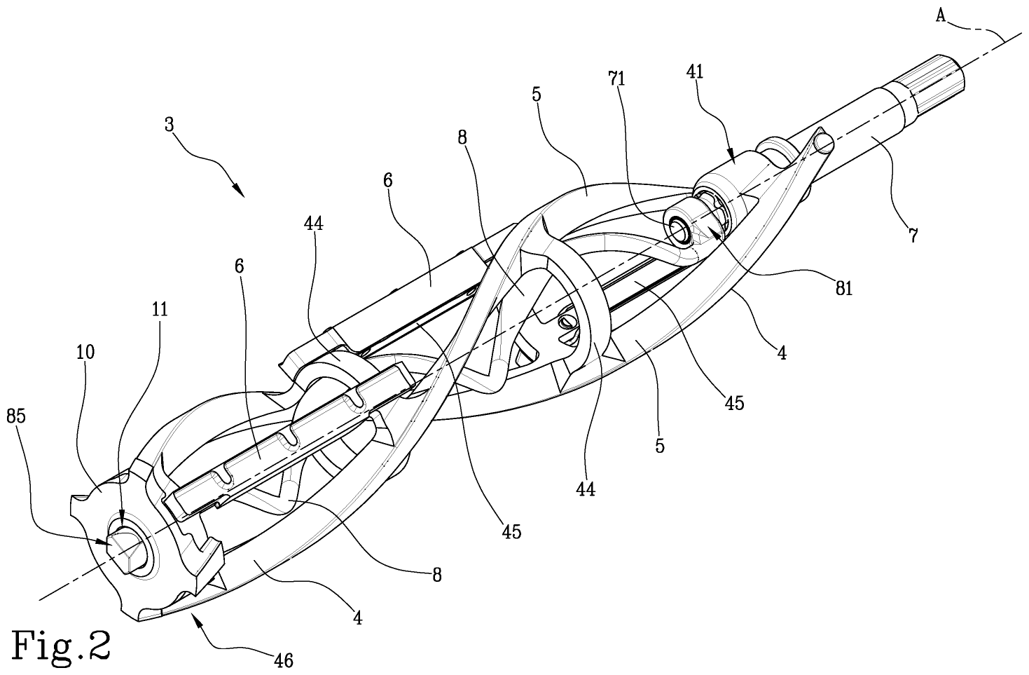

FIG. 2 illustrates a schematic perspective view of a first embodiment of a stirrer, object of the system referred to in FIG. 1;

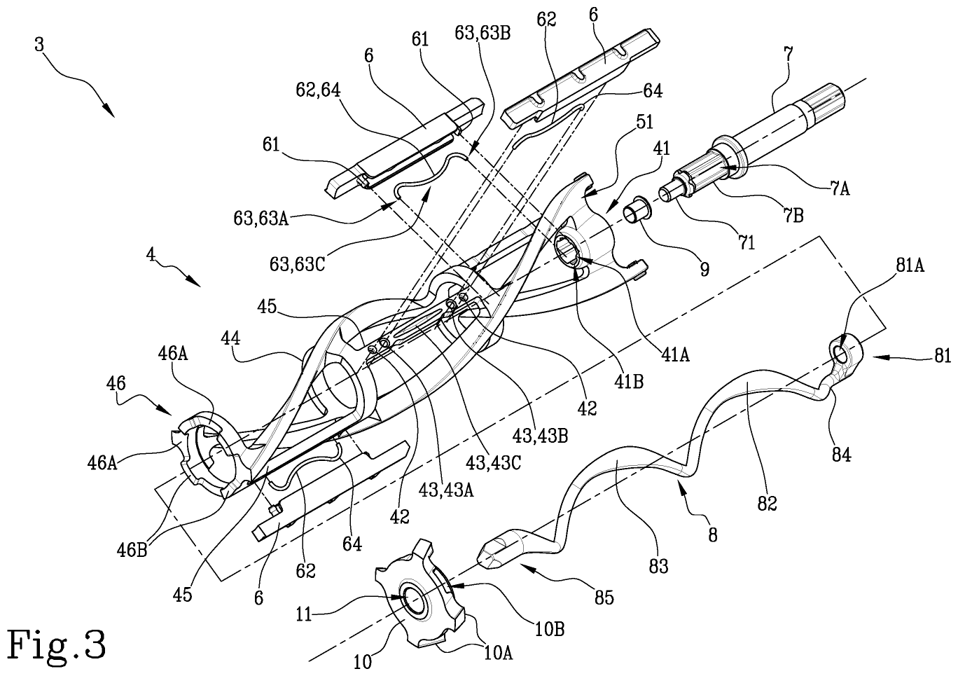

FIG. 3 illustrates in a perspective view an exploded view of the stirrer illustrated in FIG. 2;

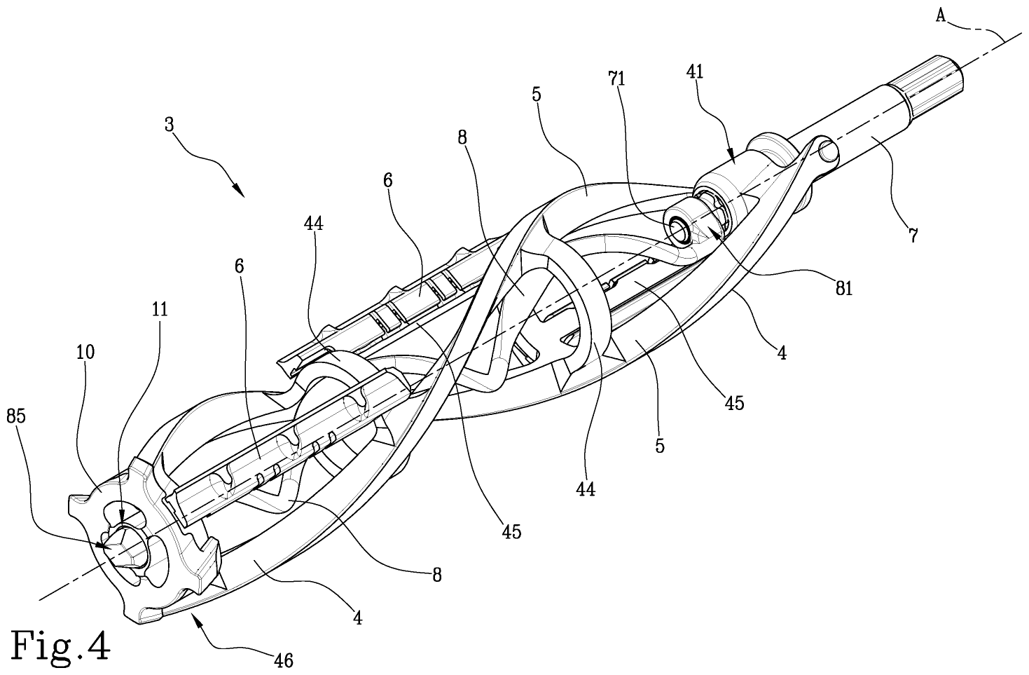

FIG. 4 illustrates a schematic perspective view of a second embodiment of a stirrer, object of the system referred to in FIG. 1;

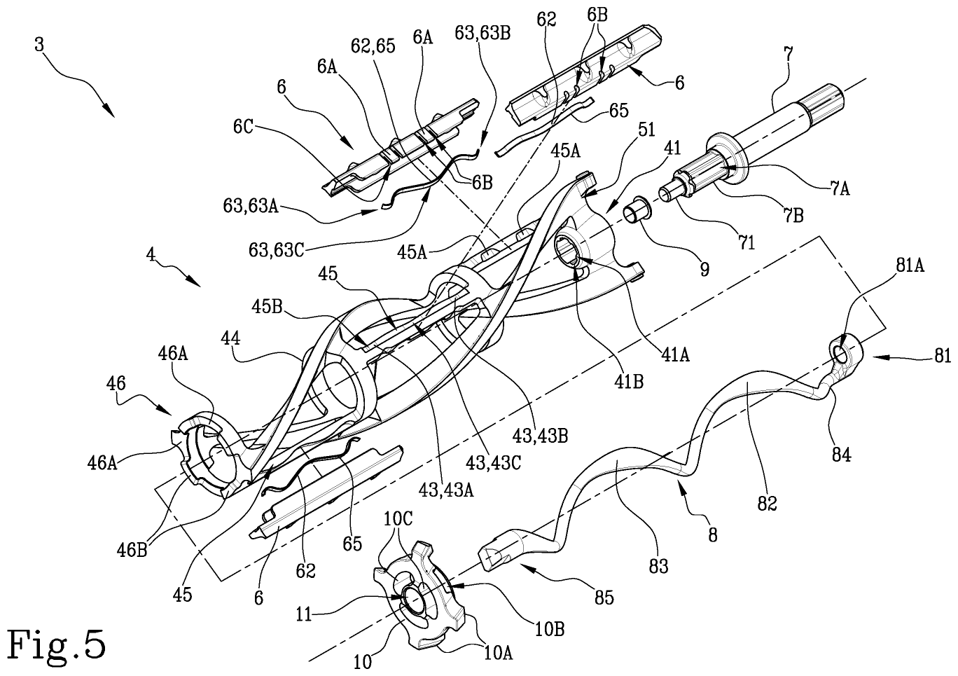

FIG. 5 illustrates in a perspective view an exploded view of the stirrer illustrated in FIG. 4.

Note that the figures are schematic and therefore not representative of the actual dimensions of the system.

With reference to the accompanying figures, the reference number 200 indicates as a whole a system for processing preferably liquid, or semi-liquid, or semi-solid food products, in particular for producing and dispensing the aforementioned products.

For example, the above food products may be ice creams, whipped cream, creams, chocolate, yoghurts, jams or other similar products.

The system 200 comprises a machine 1 for processing, in particular for producing and dispensing, liquid and semi-liquid food product.

According to the invention, the machine 1 for producing and dispensing food products comprises at least one containment vessel 2 for containing the product to be processed.

The containment vessel 2 comprises internal side and bottom walls.

According to the invention, the machine 1 for producing and dispensing food products comprises at least one stirrer 3, arranged inside the containment vessel 2.

The stirrer 3 comprises a rotating body 4 rotating about an axis A of rotation.

The rotating body 4 comprises a plurality of propellers 5 extending about the axis of rotation A.

In a preferred embodiment, the rotating body 4 comprises two propellers 5.

Preferably, the rotating body 4 is made of metallic material.

According to one aspect of the description, the rotating body 4 comprises a plurality of annular elements 44 configured to connect the propellers 5 together.

Advantageously, the annular elements 44 give greater strength to the structure of the stirrer 3.

Advantageously, a robust structure of the stirrer 3 allows mixing high density products.

In a preferred manner, the rotating body 4 comprises a plurality of bars 45, arranged parallel to said axis of rotation A.

Each bar 45 is configured to connect the annular elements 44 together, at least two by two, or to connect an annular element 44 to an end portion 51 of the propeller 5.

Advantageously, the bars 45 give greater strength to the structure of the stirrer 3.

Advantageously, a robust structure of the stirrer 3 allows mixing high viscosity products.

The stirrer 3 comprises a drive shaft 7, connectable to the rotating body 4, for rotating the rotating body itself about the axis A of rotation.

According to one aspect of the present invention, the machine 1 comprises a motor 102 connected to the drive shaft 7 of the stirrer 3 to bring the drive shaft 7 and at least the rotating body 4 into rotation about the axis of rotation A.

According to one aspect of the description, the rotating body 4 comprises a base end 41.

According to one aspect of the description, the rotating body 4 comprises a head end 46, opposite to the base end 41.

The drive shaft 7 is configured to be coupled with the base end 41 of the rotating body 4 via a shape coupling.

Such shape coupling allows the drive shaft 7 to transfer the rotational motion to the rotating body 4.

In a preferred embodiment, the base end 41 of the rotating body 4 comprises a plurality of reliefs 41A and hollows 41B and the drive shaft 7 has a plurality of hollows 7A and reliefs 7B configured to be coupled respectively with the corresponding reliefs 41A and hollows 41B of the base end 41 of the rotating body 4.

The stirrer 3 comprises a curvilinear element 8 which extends about the axis A of rotation.

Said curvilinear element 8 is configured to be inserted inside the rotating body 4 and rotatably coupled with the drive shaft 7.

According to one aspect, the curvilinear element 8 is arranged in the volume defined by the propellers 5 extending around the axis A of rotation of the rotating body 4.

For the sake of clarity, the curvilinear element 8 extends within the volume defined by the propellers 5 of the rotating body 4.

Advantageously, the presence of the curvilinear element 8 arranged inside the rotating body 4 allows to avoid a product block being formed in the centre of the containment vessel 2 during the mixing of the product itself.

In fact, in the absence of the curvilinear element 8 inside the rotating body 4, the products being mixed would tend to create a zone of greater density in the central zone of the containment vessel 2, since they would not come into direct contact with an element of the stirrer 3, for example the propellers 5, capable of breaking any thickenings.

According to one aspect, the curvilinear element 8 comprises a base end portion 81.

According to one aspect, the curvilinear element 8 comprises a head end portion 85, opposite to the base end portion 81.

In a preferred embodiment, the curvilinear element 8 has a first helical portion 82, a second helical portion 83 and a joining portion 84 for joining the first helical portion 82 to the base end portion 81.

Note that this conformation of the curvilinear element 8, combined with the presence of the propellers 5 and the arrangement of one with respect to the other, therefore allows to favour the ventilation of the product, i.e. the incorporation of air, during mixing.

The fact of increasing the amount of air inside the mixture during processing allows to increase the overall quality of the end product, that is, it increases the over-run.

More precisely, it should be noted that an at least partially helical shape of the curvilinear element 8 favours the incorporation of air inside the product during the freezing step.

This conformation also avoids or limits the possibility of forming a block of dense frozen product and on the other hand it favours the increase in volume of the frozen product, known as over-run.

Over-run, i.e. the percentage of air in the finished product, is one of the main factors that affects the creaminess of the ice cream itself or the quality of the finished product.

According to one aspect of the invention, the drive shaft 7 comprises a cylindrical-shaped portion 71.

According to one aspect of the description, the base end portion 81 of the curvilinear element 8 is configured to be rotatably coupled with the cylindrical-shaped portion 71 of the drive shaft 7.

In one embodiment, the base end portion 81 of the curvilinear element 8 has a cavity 81A complementary to the cylindrical-shaped portion 71 of the drive shaft 7.

Such rotatable coupling between the cylindrical-shaped portion 71 of the drive shaft 7 and the base end portion 81 of the curvilinear element 8 allows the curvilinear element 8 to remain independent with respect to the rotational motion of the drive shaft 7.

In other words, a rotation of the drive shaft 7, and consequently of the rotating body 4, does not imply an integral rotation of the curvilinear element 8.

In a preferred embodiment, the stirrer 3 comprises a tubular element 9 for coupling between the curvilinear element 8 and the drive shaft 7.

In other words, the tubular element 9 disengages the curvilinear element 8 from the drive shaft 7.

The tubular element 9 is, for example, a bushing, a bush or a bearing.

The tubular element 9 is configured to prevent a rotation of the drive shaft 7 from implying a similar rotation of the curvilinear element 8.

Advantageously, the presence of the tubular element 9 prevents wear by mutual rubbing of the curvilinear element 8 and of the drive shaft 7.

Advantageously, in case of wear, the tubular elements 9 are cheaper and easily replaceable than the curvilinear element 8 or the drive shaft 7.

The stirrer 3 comprises a plurality of scraping elements 6, supported by the rotating body 4.

In other words, the scraping elements 6 rotate about the axis A of rotation integrally with the rotating body 4.

The scraping elements 6 are configured, in use, to move by adhering to the internal side walls of the containment vessel 2.

Advantageously, the presence of the scraping elements 6 allows the stirrer 3 to prevent product residues from accumulating on the internal side walls of the containment vessel 2.

According to the present description, as reported in FIGS. 2 and 4, the scraping elements 6 are arranged, with respect to each other, in different longitudinal and angular positions with respect to the axis A of rotation.

In other words, considering the extension of the rotating body 4 along the direction of the axis A, the scraping elements 6 are arranged with respect to each other at different positions along said extension direction.

For the sake of clarity, with the expression “the scraping elements are arranged with respect to each other in different angular positions”, it is meant that the scraping elements 6 are not aligned with each other along the direction of axis A.

Preferably, considering the hypothetical solid generated by the propellers 5 following a complete rotation of the rotating body 4 about the axis A, the scraping elements 6 cover the entire lateral surface of said solid.

In other words, preferably, the scraping elements 6, considering a complete rotation of the rotating body 4 about the axis A, scrape the entire internal lateral surface of the containment vessel 2.

Advantageously, a different longitudinal and angular arrangement of the scraping elements 6 with respect to each other allows mixing the product inside the vessel 2 so as to limit the formation of compact blocks of the product itself and homogenize the mixing.

In a preferred embodiment, the stirrer 3 comprises a spring 62 for each of the scraping elements 6.

Each spring 62 is interposed between the rotating body 4 and the respective scraping element 6.

The springs 62 keep the scraping elements 6 in contact with the internal walls of the containment vessel 2 thus allowing by means of a regular scraping process, a uniform temperature distribution of the product inside the blending chamber.

In this way the temperature set in the pasteurization and storage step is reached in a shorter time while in the production step the possibility of a regular and distributed scraping contributes to making uniform size and distribution of the ice crystals during the steps of production of the ice cream and frozen desserts in general.

According to a further aspect, the rotating body 4 has a plurality of seats 43 configured to accommodate the springs 62, preferably to accommodate at least a portion 63 of each spring 62.

According to one aspect, each spring 62 has at least a first end 63A, a second end 63B and a central portion 63C.

In a preferred manner, the seats 43 comprise first seats 43A, configured to accommodate the first ends 63A of the springs 62, second seats 43B, configured to accommodate the second ends 63B of the springs 62 and third seats 43C, configured to accommodate the central portion 63C of the springs 62.

In an embodiment of the stirrer 3, illustrated in FIGS. 2 and 3, the first end 63A, the second end 63B and the central portion 63C are configured to be inserted into the seats 43 of the rotating body 4, preferably respectively in said first seats 43A, second seats 43B and third seats 43C.

The rotating body 4 has a plurality of cavities 42 configured to accommodate the scraping elements 6.

Preferably, said cavities 42 of said plurality of cavities 42 are through cavities.

According to one aspect of the present embodiment, each of the scraping elements 6 comprises at least one pin 61 configured to be inserted into a cavity 42 of said plurality of cavities 42.

Preferably, each of the scraping elements 6 comprises a pair of pins 61, each adapted to be inserted into a cavity 42 of said plurality of cavities 42.

In such an embodiment of the stirrer 3, the rotating body 4 receives both the insertion of the scraping elements 6 into the cavities 42 and the insertion of the springs 62 into the seats 43.

The bars 45 of the rotating body 4 may have the described cavities 42.

The bars 45 may have the described seats 43.

In a preferred manner, the bars 45 of the stirrer 3 have both the cavities 42 and the seats 43.

In other words, the bars 45 accommodate both the scraping elements 6 and the springs 62 by insertion respectively into the cavities 42 and into the seats 43.

According to one aspect of the described embodiment, the spring 62 is defined by a metallic thread-like element 64.

In a further embodiment of the stirrer 3, illustrated in FIGS. 4 and 5, each of the scraping elements 6 has a tab 6A or a plurality of tabs 6A.

In particular, the scraping elements 6 have notches 6B adapted to define the tabs 6A.

According to one aspect of the present embodiment, each tab has an abutment portion 6C.

Each abutment portion 6C is configured to be coupled with a respective portion 45A of the rotating body 4.

In other words, the scraping elements 6 comprise flaps having a shape adapted to be coupled with respective portions of the rotating body 4 so as to keep the scraping elements 6 in contact with the rotating body 4.

Preferably, the bars 45 of the plurality of bars 45 have said portions 45A of the rotating body 4.

According to one aspect of such an embodiment, each bar 45 has an indentation 45B.

The indentation 45B has the seats 43 of said plurality of seats 43.

According to the present embodiment, each spring 62 is a corrugated plate-like element 65, preferably metallic.

The expression corrugated element means an element whose profile has repeated curved raisings and depressions, even of different amplitudes.

In other words, preferably, in this embodiment, the indentation 45B accommodates the plate-like element 65, which is interposed between the bar 45 and the scraping element 6 so as to push, in use, the scraping element 6 itself away from the axis A of rotation, i.e. towards the internal lateral surface of the vessel 2.

Note that in this embodiment there is no insertion of the spring 62 into the bar 45.

Furthermore, there is no insertion of the scraping element 6 into the bar 45.

Advantageously, this embodiment facilitates and speeds up the operations of dismounting, cleaning and maintenance of the stirrer 3 and the components thereof.

Advantageously, the system 200 described, and in particular the structure of the stirrer 3 and of the elements that compose it, allows the product to be processed by mixing it so that it is particularly stable.

More precisely, the system 200 described, and in particular the structure of the stirrer 3 and of the elements that compose it favour the stability of the mixture preserving the separation between the steps of the colloid that compose the emulsion.

According to one aspect of the present invention, the stirrer 3 comprises a terminal element 10.

The terminal element 10 is configured to be coupled with the head end 46 of the rotating body 4 by means of a shape coupling.

Such shape coupling between the terminal element 10 and the head end 46 of the rotating body 4 allows the terminal element 10 to rotate about the axis A of rotation integrally with the rotating body 4.

In one embodiment, the terminal element 10 has a plurality of protrusions 10a and recesses 10B and the head end 46 of the rotating body 4 has a plurality of indentations 46A and protuberances 46B.

The protrusions 10a and the recesses 10B of the terminal element 10 are configured to be coupled respectively with the indentations 46A and the protuberances 46B of the rotating body 4 by means of a shape coupling.

According to one aspect of the description, the terminal element 10 has a cavity 11 with circular-shaped section configured to rotatably accommodate a head end portion 85 of the curvilinear element 8.

Said cavity 11 is configured to rotatably accommodate a head end portion 85 of the curvilinear element 8.

In other words, the coupling between the head end portion 85 of the curvilinear element 8 and the cavity 11 of the terminal element is such that the rotation of the terminal element 10 about the axis A does not imply a similar rotation of the curvilinear element 8.

According to one aspect of the present invention, the terminal element 10 has a plurality of through holes 10C.

According to one aspect of the present invention, the machine 1 comprises a dispensing tap 100.

The dispensing tap 100 is mounted on a discharge mouth of the containment vessel 2.

The tap 100 allows or inhibits the outflow of product from the machine 1.

Note that the propellers 5, in rotation around the axis A of rotation, are configured, by virtue of their shape, to mix the product and move it at the same time mainly towards a preferred zone, i.e. the zone of the stirrer 3 in which the terminal 10 is arranged.

According to a preferred embodiment, illustrated in FIG. 1, the stirrer 3 is oriented in the machine 1 so that the terminal element 10 is close to the dispensing tap 100.

In other words, the structure of the stirrer 3, and in particular of the propellers 5, therefore allows to mix the product and simultaneously accumulate it mainly towards a bottom wall of the containment vessel 2, in particular towards the wall near the dispensing tap 100.

This advantageously allows, by means of the propellers 5, to be able to push the product towards the tap 100, so as to provide the necessary head for a correct and fluid dispensing of product through the tap 100 itself.

Advantageously, therefore, the stirrer 3 ensures the necessary head for the dispensing of product.

According to one aspect of the present invention, the machine 1 comprises heat treatment means 101.

Said heat treatment means 101 are associated with the containment vessel 2 for heat treating the product contained therein.

According to one aspect, the heat treatment means 101 comprises at least one thermodynamic system.

The thermodynamic system comprises a closed circuit configured to circulate a heat transfer fluid.

The thermodynamic system comprises at least one heat exchanger 104, for example a condenser for cooling the heat transfer fluid, an evaporator 105 for cooling the product inside the containment vessel 2 (i.e. heating the heat transfer fluid), a compressor 106 and a lamination member 107.

In use, the heat transfer fluid along the closed loop passes through the evaporator 105, the compressor 106, the heat exchanger 104 and the lamination member 107 in order.

Note that the structure and the mechanics of the stirrer 3 allows mixing and amalgamating the product processed by the system 200 even during the cooling step.

In fact, cooling the product could lead to the creation of product blocks of different density and/or viscosity.

In particular, at the points where the product is in contact with the internal walls of the containment vessel 2 (cooled by the evaporator 105), layers of frozen (solid) mixture may form as a result of the low temperatures.

The plurality of scraping elements 6 of the stirrer 3 makes it possible to avoid the creation of such frozen (solid) layers and possibly to scrape them from the internal walls of the containment vessel 2 so that they are amalgamated again in the product being mixed.

It should also be noted that the structure of the stirrer 3 allows the scraping elements 6 to scrape the internal walls of the containment vessel 2 continuously.

More precisely, it should be specified that, in the rotation step, the stirrer 3 thanks to its shape allows, in a combined way, the movement of the mass of product in the freezing step while the scraping elements 6 remove the layer of frozen mixture from the walls allowing a continuous and uniform process of blending the liquid phase.

The joint action of stirrer 3 and scraping elements 6 also allows during the production step to incorporate air into the product, thus obtaining a finely dispersed foam, supported by the fatty phase also subjected to the action of stirrer 3.

According to a further aspect of the present invention, the machine 1 comprises a control and command unit U.

The control and command unit U is configured to drive the motor 102 and/or to control the heat treatment means 101.

In one embodiment, the machine 1 comprises an interface 103 operatively connected to the control and command unit U and configured to allow an interaction with a user.

In summary, the stirrer 3 of the system 200 allows (as explained above) to achieve, at the same time, all of the following advantages:
mixing and amalgamating the mixture during the cooling step;
generating an air exchange in the mixture;
constantly scraping the chamber wall by removing the layer of solid mixture;
providing the necessary head to expel the mixture once it is blended;
being easily disassembled (e.g. for cleaning and/or maintenance purposes).

1. A system for processing liquid or semi-liquid food products, comprising a machine provided with:
at least one containment vessel for containing the product to be processed;
a stirrer arranged inside the containment vessel;
the system being characterized in that said stirrer comprises, in combination, at least:
a rotating body rotating about an axis of rotation, said rotating body comprising a plurality of propellers extending about said axis of rotation;
a plurality of scraping elements, supported by said rotating body;
a drive shaft, connectable to the rotating body, for the rotation of the rotating body about the axis of rotation;
a curvilinear element extending around the axis of rotation and configured to be inserted inside the rotating body and rotatably coupled with the drive shaft.

2. The system according to claim 1, wherein the scraping elements are arranged, with respect to each other, in different longitudinal and angular positions with respect to the axis of rotation.

3. The system according to claim 1, wherein the rotating body comprises a base end, the drive shaft being configured to be coupled with the base end of the rotating body via a shape coupling.

4. The system according to claim 1, wherein the drive shaft comprises a cylindrical-shaped portion.

5. The system according to claim 4, wherein the curvilinear element comprises a base end portion configured to be rotatably coupled with the cylindrical-shaped portion of the drive shaft.

6. The system according to claim 5, wherein the curvilinear element has a first helical portion, a second helical portion and a joining portion for joining the first propeller portion to the base end portion.

7. The system according to claim 1, wherein the stirrer comprises a tubular element for coupling between the curvilinear element and the drive shaft.

8. The system according to claim 1, wherein the rotating body comprises a plurality of annular elements configured to connect the propellers together.

9. The system according to claim 8, wherein the rotating body comprises a plurality of bars, arranged parallel to said axis of rotation, configured to connect the annular elements together or to connect an annular element to an end portion of the propeller.

10. (canceled)

11. (canceled)

12. (canceled)

13. (canceled)

14. (canceled)

15. (canceled)

16. (canceled)

17. (canceled)

18. The system according to claim 9, wherein the bars of said plurality of bars have said portions of the rotating body.

19. (canceled)

20. (canceled)

21. (canceled)

22. (canceled)

23. (canceled)

24. (canceled)

25. (canceled)

26. (canceled)

27. (canceled)

28. (canceled)

29. The system according to claim 1, wherein the curvilinear element is arranged in the volume defined by the propellers extending around the axis of rotation of the rotating body.

30. The system according to claim 1, wherein the rotating body comprises a head end and wherein the stirrer comprises a terminal element configured to be coupled with the head end of the rotating body by means of a shape coupling so as to rotate integrally with the rotating body.

31. The system according to claim 30, wherein the terminal element has a plurality of protrusions and recesses and the head end of the rotating body has a plurality of respective indentations and protuberances, the protrusions and the recesses of the terminal element being configured to be coupled respectively with the indentations and the protuberances of the rotating body by means of a shape coupling.

32. The system according to claim 30, wherein the curvilinear element comprises a head end portion and wherein the terminal element has a cavity with circular-shaped section configured to rotatably accommodate said head end portion of the curvilinear element.

33. The system according to claim 30, wherein the terminal element has a plurality of through holes.

34. The system according to claim 1, wherein the machine comprises at least one dispensing tap mounted on a discharge mouth of the containment vessel.

35. The system according to claim 1, wherein the machine comprises heat treatment means, associated with the containment vessel for heat treating the product.

36. The system according to claim 1, wherein the machine comprises a motor connected to the drive shaft of the stirrer to bring the drive shaft and at least the rotating body into rotation about the axis of rotation.

37. The system according to claim 35, comprising a control and command unit configured to drive the motor and/or control the heat treatment means.

38. The system according to claim 37, comprising an interface operatively connected to the control and command unit and configured to allow an interaction with a user.
